(19) United States
(12) Patent Application Publication
(10) Pub. No.: US 2006/0293098 A1
(43) Pub. Date: Dec. 28, 2006

(54) Ancillary apparatus for portable information processors

(76) Inventor: Che-Wen Lin, Taipei (TW)

Correspondence Address: Che-Wen Lin, P.O. Box No. 6-57, Junghe, Taipei, 235, TW

(21) Appl. No.: 11/452,202

(22) Filed: Jun. 14, 2006

(30) Foreign Application Priority Data
Jun. 22, 2005 (TW) 094120918

(51) Int. Cl. H04M 1/00

(52) U.S. Cl. 455/575.8

(57) ABSTRACT

An ancillary apparatus for portable information processors that provides a multifunctional ancillary structure with functionality to reduce temperature, provide audio amplification and broadcasting, provide a power source, and so on, having a configuration that includes a case, a cover and coupling devices. A support device is affixed interior of the case to support the base of a portable information processor placed thereon, and a heat dissipating device produces a swirling airflow that effects a heat dissipating area of a base plate of the portable information processor. An audio amplification system installed interior of the case includes speakers and a derived resonance box from the superimposed case and cover, which enhance audio amplification and broadcasting of the portable information processor. An ancillary power source installed in the case includes a power supply device serves as a backup battery and a charge rectifying device for rectifying an external alternating current power source.

### BACKGROUND OF THE INVENTION

(a) Field of the Invention

The present invention relates to an ancillary apparatus for portable information processors, and more particularly to a multifunctional ancillary structure that includes a case, a cover and coupling devices, which has applied to install electrical devices and has functionality to reduce temperature, provide audio amplification and broadcasting, provide a power source, and so on.

(b) Description of the Prior Art

Portable information processors, such as notebook computers, handheld portable digital assistants, intelligent cell phones, digital cameras, MP3 players, and so on, are extensively used as easily and conveniently transported devices because they not only enable convenient processing and exchange of information, but are also suitable for use in any location. However, because external dimensions of the portable information processor are necessarily restricted by its compact external form, thus, its heat dissipating function is usually poor. Moreover, there is no ancillary equipment on the current market that can effectively increase the speed of temperature reduction. For instance, the heat dissipating method of a conventional ancillary fan used to dissipate the heat generated at the base of a notebook computer is only able to disperse heat in a limited space, and is unable to effectively produce air convection to transfer heat, thus, effectiveness of temperature reduction is limited, which can easily result in the failure of related components if the notebook compact is left running for a long period of time.

Furthermore, the multimedia notebook computer has already become standard equipment in recent years, thus, use of a computer is no longer purely limited to word or data processing, and the ability to play multimedia image and sound files has already become one of the indispensable functions expected in a computer by a user. However, a portable information processor, such as a notebook computer, and so on, is limited by its compactness, and it is difficult for loudspeakers and audio amplifier devices built into the portable information processor to achieve a satisfying sound effect, which creates great dissatisfaction in use.

In addition, all portable information processors, including notebook computers, handheld personal digital assistants, intelligent cell phones, digital cameras, and so on, necessarily rely on rechargeable batteries in order to maintain electrical power. However, portable information processors are limited by their compact form, thus, the batteries must also be correspondingly compact, thereby precluding prolonged use of the portable information processor because of the finite battery power stored in the rechargeable batteries, which thus affects convenience and mobility of the aforementioned portable information processors in practical use.

### SUMMARY OF THE INVENTION

A primary objective of the present invention is to provide an ancillary apparatus installed with electrical devices, which has a structure of a case, a cover and an interior holding space for containing external portable information processors, such as notebook computer, cellular phone, digital camera or personal digital assistant. The electrical device has functionality provided to the aforesaid external portable information processors, in order to reduce temperature, provide audio amplification and broadcasting, provide a power source and a power supply and so on.

Another objective of the present invention is to provide a ancillary apparatus having a structure that enables superimposing a case and a cover, and which uses coupling devices that reciprocally pivot joint the case and the cover to achieve an open and close linkage function. Moreover, regardless of whether the case and cover are in an open state or closed state, the case and cover can be fitted together to form a vertical superposition configuration by means of the coupling devices. When a user wants to proceed with information processing, a notebook computer can be placed on top of the ancillary apparatus after the case and cover have been opened up and reconfigured in a superimposed state, thereby providing a work platform for the notebook computer. When the user wishes to go outdoors, interior holding spaces of the case and the cover can be used to hold a notebook computer or other portable information processor and its peripheral equipment, and a handle affixed to the case can be used to carry the ancillary apparatus outdoors.

Yet another objective of the present invention is to provide the case structure with a heat dissipating device, and use a support device configured interior of the case to enable a portable information processor to be placed thereon and form an oblique straddling disposition, thereby creating a path for heat to obliquely swirl upwards and effect a heat dissipating area of a base plate of the portable information processor to effectively transfer heat and accelerate speed of heat exchange. The portable information processor can thus be used for long periods of time without the risk of heat accumulation, which would result in shortening the operational life span of elated components and easily cause damage thereto.

A fourth objective of the present invention is to provide the case structure with an ancillary power source, which is installed in the interior holding space of the case to provide the portable information processor with a charge rectifying device and a power supply device. When going outdoors, the portable information processor can be placed within the case, and the ancillary apparatus connect to an outdoor power source through an external connecting power source. For example, the charge rectifying device is used to step down and rectify the external alternating current power source provided by an in-car power source, thereby providing the required power supply to the portable information processor. The power supply device can be assembled from dry batteries or rechargeable batteries, and electric power range of the batteries can be selected to conform to the electric power specifications needed by the equipment being used.

A fifth objective of the present invention is to provide the case structure with the external connecting electrical coupling device, which uses the interior holding space of the case or the cover to install a plurality of external connecting ports, jacks or expansion slots, which can serve to integrate and electrically couple the portable information processor with external electrical coupling connection ports, thereby enabling the portable information processor to couple with electrical connecting cables of various specifications connected to the plurality of external connecting ports, jacks or expansion slots installed in the case, and link up with equipment such as a monitor, a printer, a scanner, and so on. Moreover, the electrical connecting cables can be integrated to form a single electrical coupling cable within the case to connect to the portable information processor. When carrying the portable information processor outside, and the ancillary apparatus is not needed, the user can conveniently unplug the portable information processor from the ancillary apparatus and the various aforementioned externally connected devices with the single electrical coupling cable.

A sixth objective of the present invention is to provide the case structure with an audio amplification system, which uses the interior holding space of the case to install the audio amplification system, which enhances audio amplification and broadcasting of the portable information processor. Audio signals input into the provide information processor are transmitted to speakers and relatively large-sized ancillary speakers installed in the case and the cover through the audio amplification system and broadcasted therefrom. Moreover, the interior space of the case and cover after superimposing the two together can serve as a resonance box.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of an ancillary apparatus according to the present invention.

FIG. 2 shows a side view depicting procedure to superimpose a cover beneath a case according to the present invention.

FIG. 3 shows a cutaway view of the relationship between a slide groove defined in the cover and a rocker arm on one side of the present invention.

FIG. 4 shows a front view depicting superposition of the case and the cover according to the present invention.

FIG. 5 shows a cross-sectional schematic view depicting movement of a support device and functioning of a heat dissipating device according to the present invention.

FIG. 6 shows a schematic view depicting the swirling air effect produced by the heat dissipating device according to the present invention.

FIG. 7 shows a schematic view depicting application of the interior holding space of the case according to the present invention.

FIG. 8 shows another schematic view depicting application of the interior holding space of the case according to the present invention.

FIG. 9 shows an exterior view of the present invention externally fitted with an audio amplification system and an electrical coupling device.

FIG. 10 shows a schematic view depicting application of the audio amplification system according to the present invention.

FIG. 11 shows a schematic view depicting application of a holding space of the cover and a locking device according to the present invention.

FIG. 12 shows a schematic view depicting placement of a notebook computer into the holding space of cover and withdrawal therefrom according to the present invention.

### DETAILED DESCRIPTION OF THE PREFERRED EMBODIMENTS

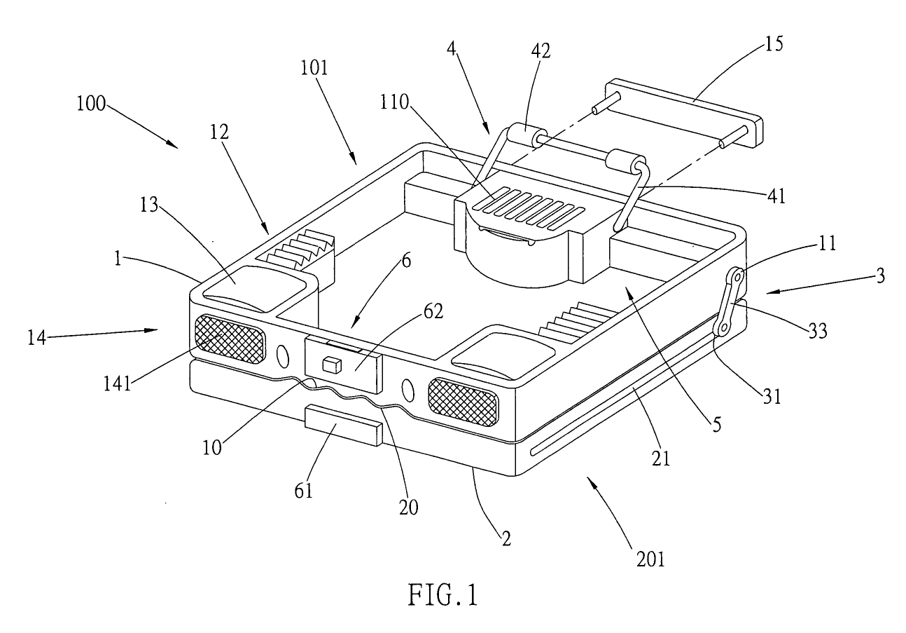

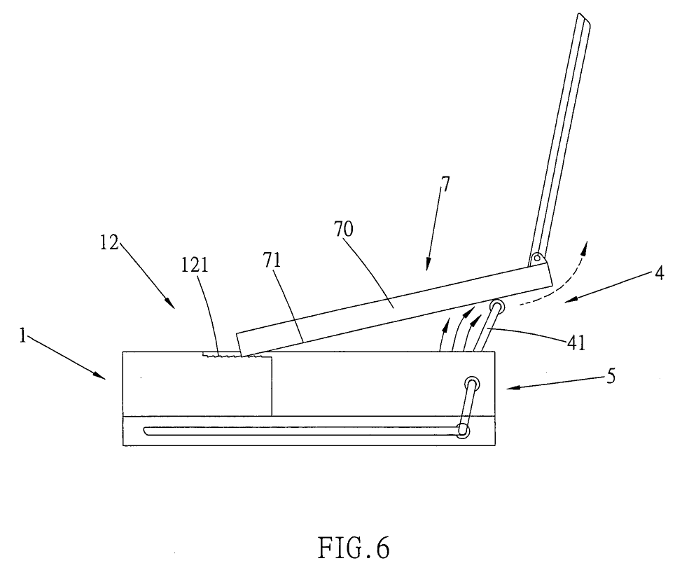

Referring to FIG. 1, which shows an ancillary apparatus 100 of the present invention primarily structured to comprise a case 1, a cover 2 and coupling devices 3. The case 1 and the cover 2 are provided with interior holding spaces 101 and 201 respectively, which enable a portable information processor 7 or other related equipment to be disposed therein (hereinafter a notebook computer 70 is taken as an exemplary example of a portable information processor). Dimensions of the case 1 and the cover 2 match each other to facilitate reciprocal fitting together thereof. The case 1 and the cover 2 are reciprocally joined by ends of the coupling devices 3 being pin joined thereto, thereby achieving an open and close linkage functionality between the case 1 and the cover 2, structure of which is characterized in that it enables vertical superposition of the case 1 and the cover 2 regardless of whether the ancillary apparatus 100 is in an open or closed state, and further enables a user to place the notebook computer 70 on top of the superimposed ancillary apparatus 100 and proceed with information processing work (see FIG. 6).

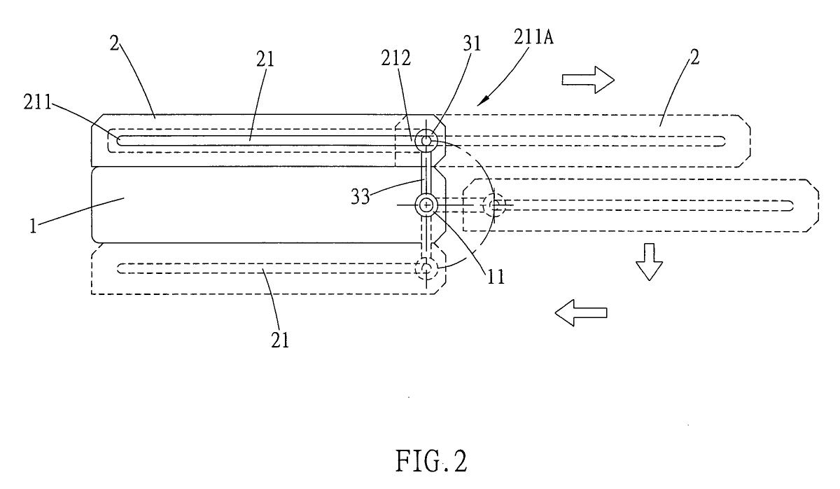

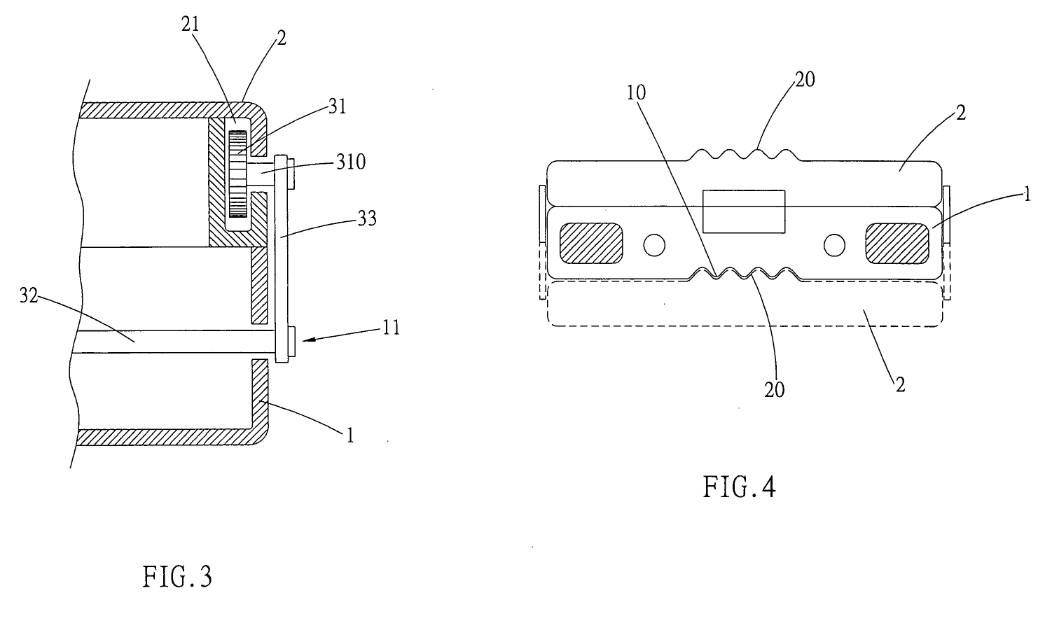

In order for the case 1 and the cover 2 to achieve a stable reciprocal fitting configuration, waveform wedge portions 10, 20 are formed on a bottom portion of the case 1 and a corresponding position of a top portion of the cover 2 respectively. When the case 1 and the cover 2 are in a superimposed disposition, the waveform wedge portions 10, 20 are used to ensure vertical positioning of the case 1 and the cover 2. Moreover, the coupling devices 3 serve as relational positioning couplings between the case and the cover 2. Referring to FIG. 2 and FIG. 3, which show one of the coupling devices 3 comprising a rocker arm 33, a pin joint portion 11, a slide axle end 31, a shaft 310 and a slide groove 21. The pin joint portion 11 at one end of the rocker arm 33 connects to the case 1, and the slide axle end 31 is configured at a free end of the rocker bar 33 relative to that of the pin joint portion 11. The slide axle end 31 is disposed so as to slide within the slide groove 21 defined in the cover 2. After the case 1 and the cover 2 are fitted together, the rocker arms 33 enable position of the case 1 to be fixed relative to a rear portion of the cover 2 by means of the slide axle ends 31, and the case 1 is snap fastened to a front portion of the cover 2 by means of a fastening member 62 and a corresponding fastening member 61, thereby achieving a snap fastening utility that prevents the case 1 and the cover 2 from coming loose after fastening together, and thus keeps objects disposed within the ancillary apparatus 100 from falling out.

Regarding the interlocking movement when storing and superimposing the case 1 and the cover 2 of present invention, when the cover 2 is in a restored state and positioned on top of the case 1, the rocker arms 33 are pivotal connected to a rear portion of the case 1 by using the pin joint portions 11 respectively movably connected to the case 1. Moreover, the slide axle ends 31 respectively configured on the free ends of the rocker arms 33 are disposed so as to slide within the respective slide grooves 21 defined in the cover 2, and are respectively positioned at rear ends 212 of the slide grooves 21. When the cover 2 is made to move backward by pushing thereon, the slide axle end 31 is made to slide along the slide groove 21, during the course of which a corresponding sliding movement of the cover 2 is enabled. When the cover 2 has reached the maximum extent of its backward movement, front ends 211 of the slide grooves 21 are now positioned at stop points 211A corresponding to position of the slide axle ends 31, whereat the slide axle ends 31 are radially rotated through a semicircle of radius equal to length of the rocker arms 33 round the pin joint portions 11, thereby moving the cover 2 backward and again forward relative to the case 1. When the cover 2 has reached lowest position, then the cover 2 is pushed forward in the opposite direction relative to the initial backward movement, and again uses the slide axle ends 31 sliding within the slide grooves 21 to enable the cover 2 to move forward and be superimposed beneath the case 1. In short, the cover 2 is pushed backward towards the rear end of the case 1, and the cover 2 is then shifted downward through a semicircular movement using length of the rocker arms 33 as axis, whereafter the cover 2 is pushed forward beneath the case 1 (or the case 1 can be moved backward towards the cover 2), thereby completing the operation to re-superimpose the case 1 and the cover 2.

Referring to FIG. 3, a movably linkage is formed between the case 1 and the cover 2 by means of the pin joint portion 11 connected to the rocker arm 33. The pin joint portion 11 is configured on left and right sides of the case 1 by means of symmetrical pivotal connections, and the two rocker arms 33 are joined through the pin joint portions 11 and a linkage shaft 32, thereby enabling synchronization of swing angle and direction of the two rocker arms 33 by means of the slide axle ends 31 movably configured within the respective slide grooves 21. Each of the slide axle ends 31 is movably connected to the respective free ends of the rocker arms 33 by means of the shaft 310. The slide axle end 31 is of cylindrical form, and a slide effect is formed between an inner periphery of the slide groove 21 and the slide axle end 31. Referring to FIG. 3, which shows a cross-sectional view depicting a cross section of the slide groove 21 as a T-shaped space, and the slide axle end 31 movably connected to the end of the rocker arm 33 by means of the shaft 310. When the cover 2 is pushed backward or forward, as depicted in FIG. 2, the slide axle ends 31 slide within the slide grooves 21 to provide for slide positioning when movably reconfiguring the cover 2 and the case 1.

Referring again to FIG. 2, when the cover 2 is pushed forward beneath the case 1, not only is the directional function of the rocker arms 33 used to regulate superposition and alignment of the case 1 and cover 2, as depicted in FIG. 4, moreover, the reciprocally corresponding waveform wedge portions 10, 20 formed on exterior surfaces of the case 1 and the cover 2 respectively are further used to enable precise alignment thereof. The waveform wedge portion 10 is formed on a bottom surface of the case 1, and the waveform wedge portion 20 is formed on a top face of the cover 2. When the cover 2 and the case 1 are brought together, the waveform wedge portion 10 formed on the bottom surface of the case 1 uses the waveform wedge portion of the cover 2 to form a wedge effect therebetween, thereby forming a stable superposition relationship between the case 1 and the cover 2.

Referring again to FIG. 1, a support device 4 is configured at a rear side of the case 1 to enable the ancillary apparatus 100 of the present invention to permit placing the notebook computer 70 on top thereof after opening the ancillary apparatus 100 from a superimposed state. Moreover, slide blocks 12 are respectively affixed to front sides within the case 1, and the interior of the ancillary apparatus 100 forms the holding space 101. The support device 4 comprises a support bar 41 and slide block members 42, wherein the support bar 41 is movably connected to the rear side of the case 1, thereby enabling a free end of the support bar 41 to rise after the support device 41 is turned upward. An oblique relationship is formed between the slide block members 42 affixed to the free end of the support bar 41 and the slide blocks 12 that depends on angle of the support bar 41 and position on the slide blocks 12, thereby enabling the notebook computer 70 to obliquely astride the support bar 41 and the slide blocks 12 when placed thereon, which further provides a heat dissipating path beneath the notebook computer 70 and the case 1. Moreover, wrist rests 13 can be attached to top surfaces of the slide blocks 12 to enable a user to rest his wrists thereon when operating the notebook computer 70 or typing. Furthermore, a handle 15 is affixed to one side of the case 1 to enable the user to carry the ancillary apparatus 100. The holding space 101 interior of the case 1 and the space 201 interior of the cover 2 enable the notebook computer 70 or any peripheral and related equipment to be disposed therein. The handle 15 can be affixed to the front side of the case 1 or the rear side of the case 1 according to structural configuration of the ancillary devise 100. The objective of the handle is to enable the user to conveniently carry the ancillary apparatus 100 when moving it elsewhere.

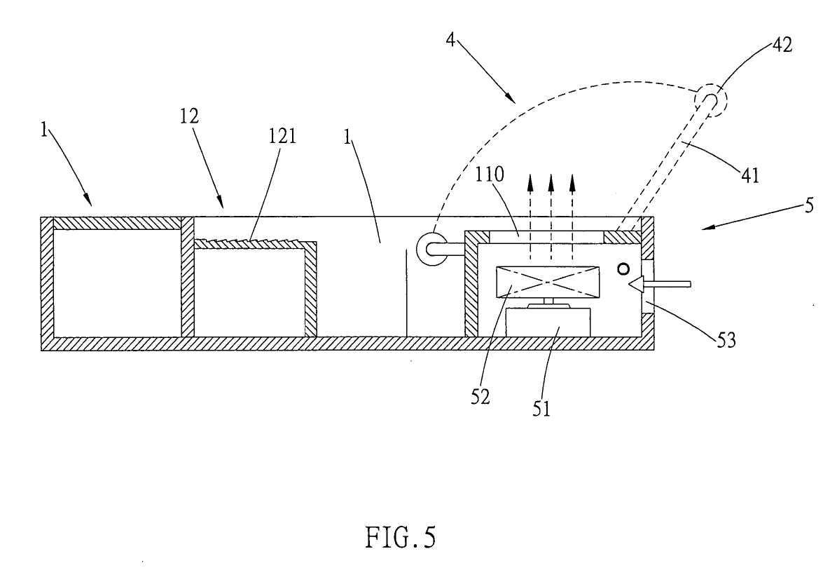

Referring to FIGS. 5 and 6, a heat dissipating device 5 is configured at the rear side of the case 1, and uses an electrically driven motor 51 to drive a paddle 52, thereby forming a swirling air effect that is forced through airholes 110. The support device 4 configuration on the rear side of the case 1 can use any method to form a movably connected structure with other component members of the case 1, and in an embodiment of the present invention the support bar 41 is movably connected to two sides of an outer case of the heat dissipating device 5 configured at the rear side of the case 1. The slide block members 42 are affixed to the free end of the support bar 41, and waveform teeth 121 can be further formed on the slide blocks 12 affixed to the front of the case 1. An oblique relationship is formed between the waveform teeth 121 and the slide block members 42 of the support bar 41 (see FIG. 6), so that, when the notebook computer 70 is placed thereon, a front end of a base plate 71 of the notebook computer 70 rests on teeth grooves of the waveform teeth 121, and a rear end of the base plate 71 straddles and rests on the support bar 41 of the support device 4. Hence, the base plate 71 rests at an angle sloping downwards on the case 1, thereby forming a triangular space between the base plate 71 and the case 1. Because heat produced by the notebook computer 70 is emitted by the base plate 71, thus, the oblique relationship between the support device 4 and the slide blocks 12, together with an airflow exchange effect between the airholes 110 and airholes 53 enable the paddle 52 to cause air to flow in and out of the heat dissipating device 5. Moreover, direction of the air passing in and out can be selected to be bidirectional. Pressure used to force the air out produces a swirling effect directly beneath the base plate 71 of the notebook computer 70, which enables fast heat exchange between the heat being emitted by the base plate 71 and the swirling outer cool air. Furthermore, the oblique configuration enables the heat to be quickly carried upwards.

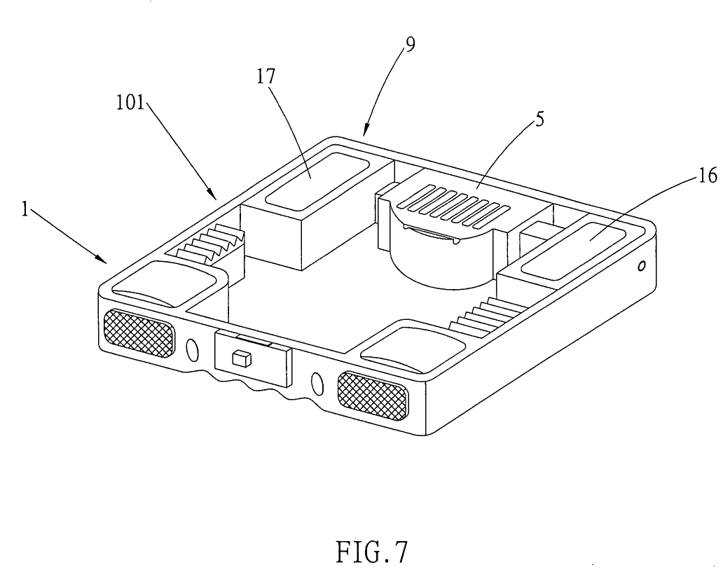

Referring to FIG. 7, in order for the heat dissipating device 5 of the present invention to form the swirling air effect, the interior holding space 101 is prescribed with an applicable height. The holding space 101 is configured with an ancillary power source 9, which further comprises a charge rectifying device 16 and a power supply device 17. The charge rectifying device 16 rectifies an external alternating current power source to supply the notebook computer 70 with direct current needed to operate, and can simultaneously recharge the rechargeable battery installed in the notebook computer 70. The power source 9 can be inbuilt or installed as an attachment. The power supply device 17 can be assembled from dry batteries or rechargeable batteries. Electric power range of the batteries can be selected to conform to the electric power specifications needed by the equipment being used. Modulation specification of the electric power range is as that used in related conventional art, and is not detailed further herein. Furthermore, apart from the interior holding space 101 holding the aforementioned power supply device 17 and the rectifying device 16, moreover, the holding space 101 enables other peripheral equipment to be disposed therein, including a compact disk drive, a camera device, a floppy disk drive, other combo-equipment or cables, and so on, and further enables the notebook computer 70 or another type of portable information processor 7 to be simultaneously disposed thereon.

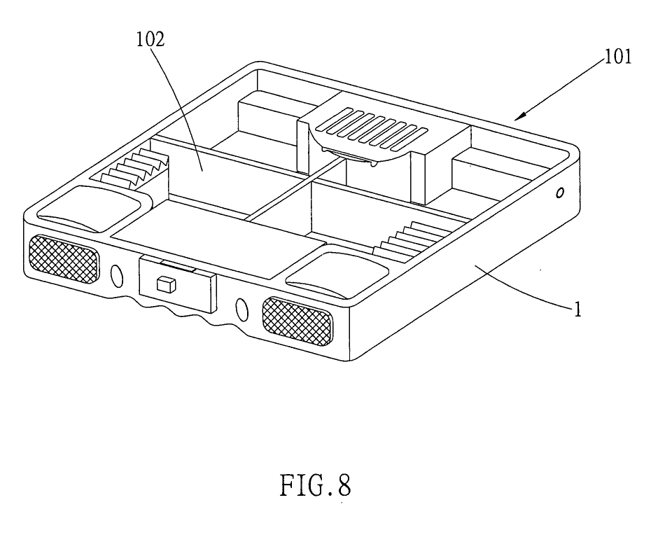

Referring to FIG. 8, the holding space 101 of the case 1 can further use partitions 102 to form block-shaped compartments, which enable different shaped and different sized equipment or peripheral devices to be disposed therein while preventing the contents from becoming disarranged when carrying the ancillary apparatus 100.

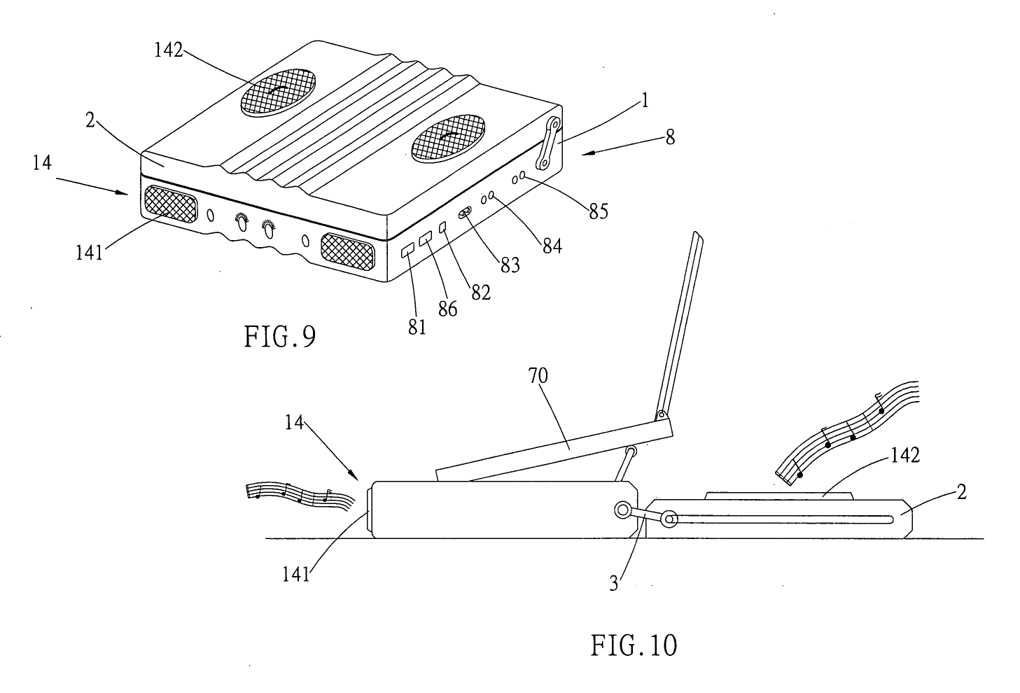

Referring to FIG. 9, which shows an electrical coupling device 8 configured on one side of the case 1. The electrical coupling device 8 has a plurality of connection ports and jacks for connecting to external devices, including a USB port 81, a columnar direct current input jack 82 and an alternating current input jack 83, which enables an alternating current or car power source to electrically connect with the ancillary power source 9 (see FIG. 7), a circular rod-shaped input terminal 84, a quincunx terminal 85 and an expansion slot 86 (for instance, a small computer system interface (SCSI)). The electrical coupling device 8 enables the case 1 to electrically couple with external electrical devices, and can serve to integrate the notebook computer 70 or other portable information processor 7 (for examples, personal digital assistant, cellular phone or digital camera) with external electrical coupling connection ports. For example, the expansion slot 86 can be used to externally connect to equipment including a monitor, a printer, a scanner, and so on. Moreover, the electrical coupling device 8 can be further configured with other external connection ports and jacks such as a monitor (VGA) port, an IEEE1394 port, a RJ-11 modem terminal, a RJ45 network terminal, an earphone jack, a speakers jack, a circuit output terminal, and so on (not shown in the drawings).

Electrical connecting cables of various specifications can be connected in the case 1, thereby enabling a plurality of external connection ports and jacks or expansion slots to be installed therein. Moreover, the electrical connecting cables can be integrated to form a single electrical coupling cable within the case 1 to connect to the notebook computer 70. When carrying the notebook computer 70 outside, and the ancillary apparatus 100 is not needed, the user can conveniently unplug the notebook computer 70 from the ancillary apparatus 100 and the various aforementioned externally connected devices with the single electrical coupling cable.

Furthermore, an audio amplification system 14 is installed in a front side of the case 1, and the audio amplification system 14 is used to amplify audio frequency signals, which are then broadcasted through speakers 141, thereby enabling input audio signals to be amplified through the audio amplification system 14 and broadcasted (the audio amplification system 14 comprises a normal circuit internally installed within the case 1, and is not further detailed herein). Because form and structure of the speakers 141 are restricted by the thickness of the case 1, thus, the audio frequency energy and sound effect produced by the audio amplification system 14 through the speakers 141 is correspondingly limited, and bandwidth is inadequate. However, to compensate, substantially larger ancillary speakers 142 are further installed in the cover 2 of the present invention, which can broadcast audio frequency signals of relatively larger energy. Moreover, after the case 1 and the cover 2 are fitted together, the interior space of the case 1 and the cover 2 can be used as a resonance box.

Apart from the aforementioned multiple ancillary functions, moreover, the present invention can also be configured for use as a single unit player device. After receiving input audio frequency signals, the audio amplification system 14 actuates the speakers 141 and the ancillary speakers 142, and the audio frequency range of the speakers 141 and the ancillary speakers 142 can be modulated to within a suitable frequency range, for example, to a bandwidth range between 120 Hz and 18 Hz, thereby making the ancillary apparatus 100 suitable for playing normal music or human sounds.

Referring to FIG. 10, when wanting to use the notebook computer 70, the cover 2 can be first pushed backward, whereafter the rocker arms 3 function to enable the cover 2 to be laid flat on a desktop, thus enabling the interior space of the cover 2 to form a resonance box. The ancillary speakers 142 vibrate to input audio frequency signals, and the entire cover 2 is used to produce a resonant effect. Moreover, the speakers 141 at the front end of the case 1 also broadcast the audio frequency signals. Hence, when the cover 2 is pushed backward and laid flat on a desktop, the cover 2 can be used to produce a resonant effect and serve to lower the audio frequency.

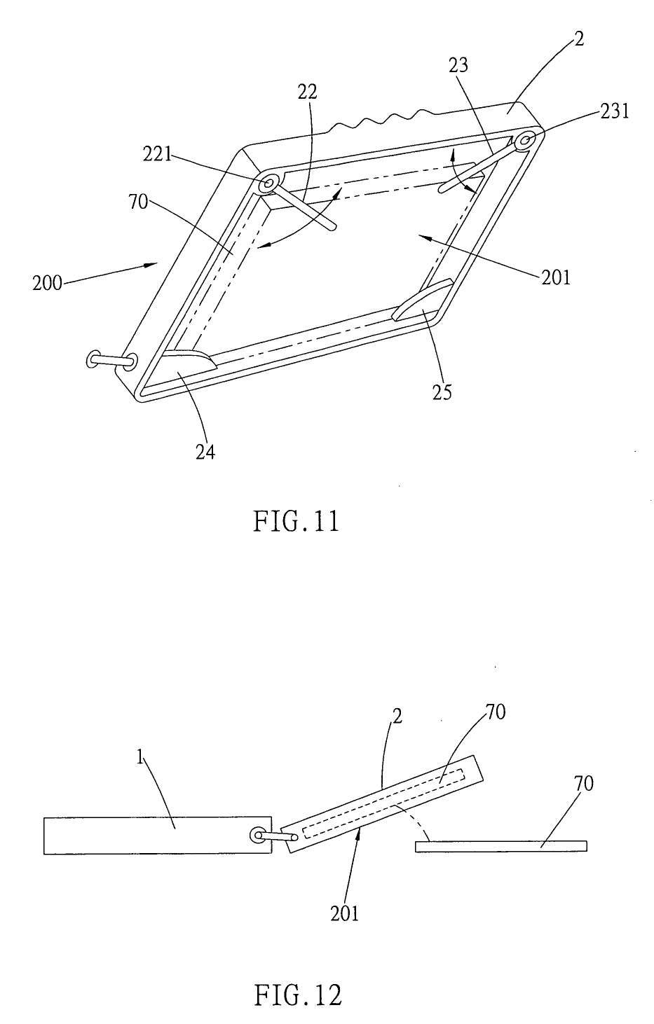

Referring to FIGS. 11 and 12, the interior space 201 of the cover 2 can not only be used to install the aforementioned speakers 142 therein, but also a portion of the space 201 can be vacated to enable the notebook computer 70 or a book to be disposed therein, which is implemented by having a locking device 200 configured at an open end of the cover 2. The locking device 200 can be conventional hook and loop type fastening strips or rods or any other movably fastening members. An embodiment of the present invention uses simple mechanically adjustable rods 22, 23 and holding pieces 24, 26 respectively affixed opposite thereto to serve as a complementary fastening structure.

Procedure to place the notebook computer 70 within the space 201 of the cover 2 involves first pushing open the adjustable rods 22, 23, which then enables the notebook computer 70 to be disposed within the space 201 by first placing a lower edge of the notebook computer 70 within the holding pieces 24, 25, and then leveling the notebook computer 70 so as to fit snugly within the cover 2. The adjustable rods 22, 23 are then pushed back over the notebook computer 70 so as to fasten down the two corners of the upper edge of the notebook computer 70. The adjustable rods 22, 23 are respectively movably connected to opposite corner positions of the cover 2 using pivotal connected shafts 221, 231 respectively. A single rod or other single fastening member can be adopted to implement placement of the notebook computer 70, however, resilience is required in the fastening rods or members in order to facilitate press fitting the notebook computer 70 into a secure placement position. Furthermore, any shockproof material can be attached to edges of the interior space 201 corresponding to edges of the notebook computer 70 to be disposed therein.

Referring to FIG. 12, which shows method of placement and withdrawal of the notebook computer 70 whereby the cover 2 is first separated from the case 1 using functionality of the aforementioned coupling devices 3, and then placement or withdrawal of the notebook computer 70 from the open end of the cover 2 can be carried out. Moreover, after placing the notebook computer 70 into the cover 2, the locking device 200 functions to fasten down and secure placement of the notebook computer 70 without affecting configurational manipulation of the cover 2 and the case 1.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An ancillary apparatus for portable information processors, comprising a case, a cover, a coupling device and at least one electrical device, wherein interior holding spaces of the case or the cover enable a portable information processor to be placed therein, dimensions of the case and the cover match each other to facilitate reciprocal fitting together thereof, and the case and the cover are pivotly joined the coupling device, thereby achieving an open and close linkage function; the electrical device is installed to enable ancillary functions applied to the portable information processor.

2. The ancillary apparatus for portable information processors according to claim 1, wherein the coupling device comprises at least one pivot joint portion, thereby enabling the case and the cover to achieve an open and close linkage function.

3. The ancillary apparatus for portable information processors according to claim 1, wherein the coupling device comprises a rocker arm, a pivot joint portion, a slide axle end, a shaft and a slide groove; the pivot joint portion is joined to one end of the rocker arm and movably connected to the case, the slide axle of another end of the rocker arm and movably connected to the cover; the shaft connects the slide axle end and the rocker arm; the slide groove is defined in a side of the cover to enable the slide axle end to be disposed and slide therein.

4. The ancillary apparatus for portable information processors according to claims 1, wherein the coupling device comprises a linkage shaft, which connects the pin joint portions respectively joined at the ends of the rocker arms configured on two sides of the case, thereby enabling synchronous and stable sliding displacement of the shafts and the slide axle ends at the other ends of the rocker arms within the slide grooves defined in the two sides of the case.

5. The ancillary apparatus for portable information processors according to claims 1, wherein reciprocally corresponding waveform wedge portions are formed on outer surfaces of the case and the cover, which are used to ensure a positioning relationship between the case and the cover when sliding and superimposing the case and the cover.

6. The ancillary apparatus for portable information processors according to claim 1, wherein the electrical device further comprises at least one external coupling device such as connecting port or jack.

7. The ancillary apparatus for portable information processors according to claim 6, wherein the external coupling device comprises USB ports, direct current input jacks, alternating current input jacks, circular rod-shaped input jacks, quincunx input jacks and expansion slots.

8. The ancillary apparatus for portable information processors according to claims 1, wherein wrist rests are attached to the case that enable a user's wrists to rest thereon when operating a portable information processor.

9. The ancillary apparatus for portable information processors according to claims 1, wherein a handle is attached to the case that enables a user to carry the ancillary apparatus.

10. The ancillary apparatus for portable information processors according to claims 1, wherein at least one partition are attached interior of the case that facilitate separating articles disposed within the interior holding space of the case.

11. The ancillary apparatus for portable information processors according to claims 1, wherein the case and the cover is configured with at least one fastening device, which enables the case and the cover to be fastened together.

12. The ancillary apparatus for portable information processors according to claim 1, wherein the electrical device further comprises a heat dissipating device; the heat dissipating device is installed within the interior holding space of the case, wherein position of the heat dissipating device corresponds to the base of a portable information processor when placed on top of the case, thereby enabling effective heat dissipation therefrom.

13. The ancillary apparatus for portable information processors according to claim 12, wherein the heat dissipating device comprises a fan, a motor and air holes, which enable the dissipation of heat from a portable information processor.

14. The ancillary apparatus for portable information processors according to claims 1, wherein a support device is configured within the case to support the base of a portable information processor placed thereon.

15. The ancillary apparatus for portable information processors according to claim 14, wherein the support device comprises a support bar and slide block members.

16. The ancillary apparatus for portable information processors according to claims 1, wherein slide blocks are affixed within the case to prevent the base of a portable information processor from sliding when placed thereon.

17. The ancillary apparatus for portable information processors according to claim 1, wherein the electrical device further comprises an ancillary power source; the ancillary power source is installed within the case to provide the required power supply to a portable information processor.

18. The ancillary apparatus for portable information processors according to claim 17, wherein the ancillary power source comprises a charge rectifying device.

19. The ancillary apparatus for portable information processors according to claim 17, wherein the ancillary power source comprises a power supply device.

20. The ancillary apparatus for portable information processors according to claim 1, wherein the electrical device further comprises an audio amplification system; the audio amplification system is installed within the interior holding space, thereby providing a portable information processor with enhanced audio amplification and broadcasting functionality.

21. The ancillary apparatus for portable information processors according to claim 20, wherein the audio amplification system comprises at least one speaker.

22. The ancillary apparatus for portable information processors according to claims 1, wherein a locking device is configured in the interior holding space of the cover that enables securing a portable information processor after placing placement within the cover.

23. The ancillary apparatus for portable information processors according to claim 22, wherein the locking device comprises adjustable rods, holding pieces and pivotal connected shafts.
